(19) United States
(12) Patent Application Publication
(10) Pub. No.: US 2001/0052030 A1
(43) Pub. Date: Dec. 13, 2001

(54) Command processing apparatus

(76) Inventor: Nobuhisa Shiraishi, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/733,939

(22) Filed: Dec. 12, 2000

(30) Foreign Application Priority Data
Dec. 14, 1999 (JP) 11-354978

(51) Int. Cl. G06F 9/00; G06F 9/54; G06F 15/163

(52) U.S. Cl. 709/310

(57) ABSTRACT

The command processing apparatus of the present invention can display help information corresponding to the context of a command which is being input, can display candidates of words corresponding to the context, can allow the user to request command execution out of a plurality of displayed candidates, and can accept abbreviated command character strings. The command processing apparatus comprises: a command correspondence table retriever for retrieving program execution information from a command correspondence table which stores the relationships between command pattern strings and program execution information for executing processes corresponding to the command pattern strings based on an input character string; and a command execution controller for executing a program based on the program execution information obtained by the command correspondence table retriever.

### BACKGROUND OF THE INVENTION

1. Field of the Invention

The present invention relates to a command processing apparatus in a computer system, a command processing method, and a storage medium which stores the computer program for performing the method and, in particular, to an apparatus, method, and storage medium which can easily add a new command, can assist the input of a command, and can display help information to a user.

2. Description of the Related Art

When operating a computer system, such as a communicator, or a controller, which is incorporated in a machine, a new function may often be added to a general purpose operating system such as UNIX. The cost for the addition is lower than the cost for the development of an operating system dedicated to each machine. The reason for this is that a user interface can be developed based on a command system well known to computer engineers with ordinary skill in the art.

The commands for the general purpose operating system are mainly intended to process text stored in files, and to handle the file system. The communicator and controller require a number of commands for operating the control targets, and the commands are developed and implemented by adding them to the command system which the operating system inherently has.

In general, the addition of a new function through the reconstruction of the existing computer program requires more steps than the process for simply developing only the new function. The reason for this is that the specifications of the existing computer system must be studied, and its operations must be tested. It is desired to minimize the number of extra steps. In particular, in the fields in which technology has progressed rapidly, e.g., in the fields of routers and switches for computer communication, the reduction of the number of steps is advantageous because the life cycles of the products are short, and because new functions are frequently added.

Because the above-mentioned devices do not take into consideration users inexperienced in computer technology, and because hardware resources, such as a CPU, and a memory, are effectively used, a GUI (Graphical User Interface) for allowing the users to easily operate the devices is not frequently employed, and a text-based user interface is mainly used. For example, in UNIX, the shell system to which necessary commands are added is preinstalled into the computer.

In a conventional UNIX shell system configuration, information regarding the phrases of command character strings and syntax, and the functions of the commands are not separated in an orderly manner. The execution functions having the functions of the commands are buried into a large amount of program codes. Therefore, to add a new command in order to expand the shell, the program codes must be analyzed.

To make use of the device, a user must memorize the command system originally added to the device, in addition to the command system which the general purpose operating system inherently has, or must input the desired commands while reading a user manual to set the operating environment of the device for daily operation. Although there are command processing systems with help functions, the systems display help information simply regarding the words in the command strings, and skill is required to manage the command system.

### BRIEF SUMMARY OF THE INVENTION

It is therefore an object of the present invention to improve the modules of the command processing programs, to easily add a new function and command, and to easily change the existing functions. Further, it is another object of the present invention to provide a command processing apparatus, a command processing method, and a storage medium which stores the computer program for performing the method, which can display help information corresponding to the context of the command which is being input, which can display candidates of words corresponding to the context, which can allow the user to request a command to executed out of a plurality of displayed candidates, and which can accept abbreviated command character strings.

As a first aspect of the present invention, the command processing apparatus comprises: a command parser (analyzer) for parsing a command pattern string, based on an input character string, and for obtaining program execution information corresponding to the command pattern string: and a command execution controller for executing a program, based on the program execution information obtained by the command parser.

As a second aspect of the present invention, the command processing apparatus comprises: a command correspondence table retriever for retrieving program execution information from a command correspondence table which stores the relationships between command pattern strings and program execution information for executing processes corresponding to the command pattern strings based on input character strings: and a command execution controller for executing a program based on the program execution information obtained by the command correspondence table retriever.

When the command correspondence table retriever performs the retrieval from the command correspondence table, the entry is extracted based on whether the input character string matches the command pattern string. The matching process is not limited to a complete matching process, and may be a partial matching e.g., a beginning matching method for finding a word whose beginning matches each word in the character string. The command pattern may contain meta-symbols, e.g., symbols which match any arbitrary character string, any arbitrary value, or any arbitrary communication address. The correspondence table may be provided within the command processing apparatus. Alternatively, the command correspondence table may be provided outside the apparatus, and the may be referred to by the command correspondence table retriever using a communicator. The program execution information specifies the program and enables the access to the program, and may be the file name which records the program codes, the address of the program codes in the memory, the address of the program codes in a secondary storage unit, or a combination thereof. The input character string is input from an input terminal, and may be read from a file.

Thus, the program execution information corresponding to the input character string is obtained by the pattern matching method based on the input character string. The command corresponding to the input character string is executed based on the program execution information. Since the program execution information corresponding to the respective commands are written in the command correspondence table, and since the program is executed based on the execution information in the command correspondence table as a module, the command processing program can be improved in that a command can be easily added, thereby improving the productivity.

As a third aspect of the present invention, the command correspondence table retriever retrieves an explanation corresponding to the input character string in the command correspondence table, and displays the explanation.

The command correspondence table retriever can display help information corresponding to the input character string to the user. The command correspondence table registers both complete entries having complete executable command pattern strings, and incomplete entries having pattern strings containing a plurality of words which are portions of the complete command pattern strings. The entries have the explanation information. Thus, the user can obtain appropriate help information depending on the context of the command which is being input.

As a fourth aspect of the present invention, the command processing apparatus internally stores the correspondence table which stores the relationships between command pattern strings and program execution information for executing processes corresponding to the command pattern strings.

The command correspondence table retriever can reference the internal command correspondence table at a high speed without any communicator.

As a fifth aspect of the present invention, the correspondence table stores explanation information corresponding to the command pattern strings.

The command correspondence table retriever can reference0 the internal command correspondence table without any communicator, and can obtain the explanation information at a high speed.

As a sixth aspect of the present invention, the command correspondence table retriever retrieves the command pattern string from the command correspondence table by a pattern matching method based on the input character string, and displays the obtained complete command pattern string to a user.

Even when the input character string is incomplete, the pattern matching process extracts the entry registered in the command correspondence table, completes the command, and displays the command to the user. Further, the command execution controller executes the program, based on the program execution information corresponding to the completed command.

As a seventh aspect of the present invention, the command correspondence table retriever performs the retrieval from the command correspondence table using a beginning matching method for finding a word, contained in the command pattern strings in the command correspondence table whose beginning matches each word in the incomplete input character string.

Even when the words in the input character string are incomplete, the command is completed based on the command pattern string in the command correspondence table.

As an eighth aspect of the present invention, during in the retrieval when the input character string corresponds to a plurality of command pattern string candidates, the command correspondence table retriever shows a list of information regarding the candidates to a user.

As a ninth aspect of the present invention, during in the retrieval when the input character string corresponds to a plurality of command pattern string candidates, the command correspondence table retriever obtains program execution information of one of the candidates, and the command execution controller executes a program based on the program execution information.

When the command corresponding to the input character string is unclear, a plurality of possible candidates are displayed. The user can select one of the candidates, and can execute the command.

As a tenth aspect of the present invention, the command correspondence table retriever performs the retrieval from a parameter table associated with the command correspondence table using a matching method for finding a second command pattern string which is produced by arranging the parameters in an arbitrary order which matches the input character string.

Even if the command has parameters which have no specific order, the command correspondence table does not require entries for all permutations (patterns) of the parameters.

As an eleventh aspect of the present invention, the command processing apparatus further comprises a parameter table, associated with the command correspondence table, for storing information regarding parameters which have no specific order.

The command correspondence table retriever can reference the internal parameter table at a high speed without any communicator.

As a twelfth aspect of the present invention, the program execution information reports position information indicating an entry point of a corresponding executable program file.

The entry point is the position in the command code which is to be first executed by the program code. The position information is an address in the memory space to which the program codes are loaded, or an address in the secondary storage unit which stores the program codes. The program execution controller properly executes the program based on the position information.

As a thirteenth aspect of the present invention, the program execution information reports information for identifying a corresponding executable program file.

The program execution controller reads the file based on the information identifying the file, loads the file into the memory space, and properly executes the program.

As a fourteenth aspect of the present invention, the command correspondence table retriever identifies a user who inputs the character string, and performs the retrieval from one of the command correspondence tables based on the identification.

With this structure, a different command system can be provided for each user, or for each class of user. The identification of the user is based on a user ID and a password. Because the command systems for the respective users are different, the security of the system can be improved, preventing the unauthorized execution of the command.

As a fifteenth aspect of the present invention, the communicator comprises: a command processing apparatus comprising a command parser for parsing a command pattern string based on an input character string, and for obtaining program execution information corresponding to the command pattern string, and a command execution controller for executing a program based on the program execution information obtained by the command parser; and an address memory unit for storing information regarding an address for communication. The command correspondence table retriever displays an explanation of a command for controlling the communication, based on the address stored in the address memory.

The communicator can display help information to the user, and completes an incomplete input command. Further, as a module, the command processing program can be improved in that a command can be easily added, thereby improving the productivity. Help information can be displayed to the user, based on the information stored in the address memory.

The communicator is, for example, a telephone switchboard, or a computer communicator. Specifically, the computer communicator can be a switch, a router, or a hub.

As a sixteenth aspect of the present invention, the computer system comprises: a command processing apparatus comprising a command parser for parsing a command pattern string based on an input character string, and for obtaining program execution information corresponding to the command pattern string, and a command execution controller for executing a program, based on the program execution information obtained by the command parser; and a command correspondence table which is accessed by the command processing apparatus through a communication network.

Examples of the communication network are a LAN (Local Area Network), WAN (Wide Area Network), Internet, intranet, or extranet, provided by cable communication or radio communication. The present invention allows a plurality of command processing apparatuses to have a command correspondence table in common, thereby facilitating the maintenance of the command correspondence table.

As a seventeenth aspect of the present invention, the command processing method comprises: a command parsing step of parsing a command pattern string, based on an input character string, and of obtaining program execution information corresponding to the command pattern string; and a function execution step of calling a program, based on the program execution information obtained in the command parsing step.

As an eighteenth aspect of the present invention, the command processing method comprises: a command correspondence table retrieval step of retrieving program execution information from a command correspondence table which stores the relationships between command pattern strings and program execution information for executing processes corresponding to the command pattern strings based on an input character string: and a command execution step of calling a program based on the program execution information obtained in the command correspondence table retrieval step.

As a nineteenth aspect of the present invention, the command processing method further comprises a syntax analysis step of parsing the input character string according to a predetermined rule, and of extracting words contained in the input character string based on the results of the syntax analysis step.

With this method, the input character string, which is irregular in terms of the type and number of delimiters separating the words, can be modified to a regular form, and lengthy entries can be eliminated from the command correspondence table.

As a twentieth aspect of the present invention, the command correspondence table retrieval step receives the words obtained in the syntax analysis step, and performs the retrieval using a partial matching method.

As a twenty-first aspect of the present invention, the command correspondence table retrieval step receives the words obtained in the syntax analysis step is received, and performs the retrieval using a beginning matching method.

As a twenty-second aspect of the present invention, the command correspondence table retrieval step obtains a character string corresponding to a word contained in the input character string, and replaces a part of the input character string with the obtained character string.

The corresponding command can be called based on the incomplete words which the user has input. Therefore, even when the user does not remember the command statement, the user can interactively call the desired command.

As a twenty-third aspect of the present invention, the computer-readable storage medium contains program instructions for performing: a command correspondence table retrieval step of performing a retrieval from a command correspondence table, based on an input character string, and obtaining position information of an execution function corresponding to the input character string; a function execution step of calling the execution function, based on the position information obtained in the command correspondence table retrieval step; and a command processing step of causing the computer to execute the execution function.

As a twenty-fourth aspect of the present invention, the computer-readable storage medium further contains program instructions for performing a syntax analysis step of parsing the input character string according to a predetermined rule, and of extracting words contained in the input character string based on the results of the syntax analysis step.

With the program, the input character string, which is irregular in terms of the type and number of delimiters separating the words, can be modified to a regular form, and lengthy entries can be eliminated from the command correspondence table.

As a twenty-fifth aspect of the present invention, the command correspondence table retrieval step obtains a character string corresponding to a word contained in the input character string, and replaces a part of the input character string with the obtained character string.

The corresponding command can be called based on the incomplete words which the user has input. Therefore, even when the user does not remember the command statement, the user can interactively call the desired command.

According to the present invention, the command pattern is predicted based on the input character string, and the executable program is called based on the command pattern string. Therefore, even when the input character string is incomplete, the corresponding command function can be executed. Even a user, who does not completely remember the command statements, can easily use the command processing apparatus.

All of the commands are registered in the command correspondence table, and the addresses of the executable functions corresponding to the commands are stored in the command correspondence table. The retrieval from the command correspondence table based on the input character string can specify the corresponding command pattern string, and obtain the program execution information corresponding to the command. Therefore, as a module, the system is improved in that a new command can be easily added. When adding an original function to the general purpose operating system to develop a new command processing system, the present invention simplifies the designing step, and reduces the number of steps.

The command correspondence table stores the explanations corresponding to the command character string. The retrieval from the command correspondence table can obtain and display the explanation from the entry which matches the input character string. Therefore, even a user, who does not completely remember the command statements, can easily use the command processing apparatus.

The retrieval from the command correspondence table extracts not only the entry which completely matches the input character string, but also the entries which partially match the input character string, and may employ a matching process utilizing a template symbol. Therefore, complete command character strings can be produced from various incomplete command character strings by the completion function. A plurality of candidates can be displayed so that the user can select one of them. Thus, the user can easily handle the command processing apparatus.

The parameter table associated with the command correspondence table stores the parameters which have no specific order. During the retrieval from the command correspondence table, the parameter table provides a plurality of command pattern strings with the parameters in arbitrary orders, any of which may match the input character string. Lengthy entries can therefore be eliminated from the command correspondence table.

Since different command correspondence tables can be prepared for the respective users, even a single command processing apparatus can provide different command systems to the users. The system can be implemented so that the different systems can be provided depending on the authorization of the users.

The communicator displays the address information stored in the address memory. The user can input the command and operate the system according to the detailed explanation depending on the operating environment.

### BRIEF DESCRIPTION OF THE DRAWINGS

FIG. 1 is a block diagram showing a shell system (command processing apparatus) of the present invention.

FIG. 2 is a table showing an example of the command correspondence table and the data of the present invention.

FIG. 3 is a flowchart showing the process of operation of the shell system of the present invention.

FIG. 4 is a diagram showing an example of the command correspondence table and the data in another embodiment of the present invention.

### DETAILED DESCRIPTION OF THE INVENTION

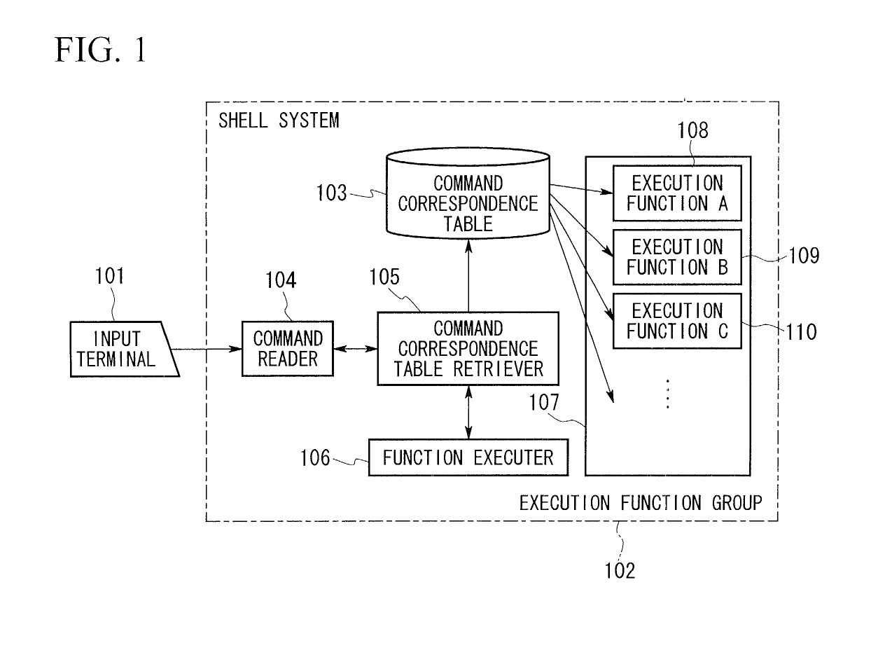

An embodiment of the present invention will be explained with reference to the figures. The shell system of the embodiment can flexibly expand its functions by displaying the explanations of words and by adding commands. FIG. 1 is a block diagram showing the configuration of the shell system.

In FIG. 1, reference number 101 denotes an input terminal, and reference number 102 denotes the shell system (command processing apparatus). A command reader 104 in the shell system 102 reads a command input from the input terminal 101, and sends it to a command correspondence table retriever 105 which includes a parser (analyzer) for parsing (analyzing) the command. The command correspondence table retriever 105 analyzes the syntax of the input character string, and performs the retrieval from a command correspondence table 103, based on a word extracted from the character string according to the analysis. The command correspondence table 103 stores information indicating the positions of the execution functions corresponding to the respective commands. The position information enables access to the functions in a execution function group 107. The position information obtained during the retrieval by the command correspondence table retriever 105 is sent to the function executer 106 (command execution controller), which then executes the command which has been input from the input terminal 101.

The shell system has been developed based on a general purpose operating system. To add a command required for the device which includes a shell system, an execution module which is to be added to the execution function group 107 is prepared, and the entry corresponding to the command added to the execution function group 107 is registered in the command correspondence table 103.

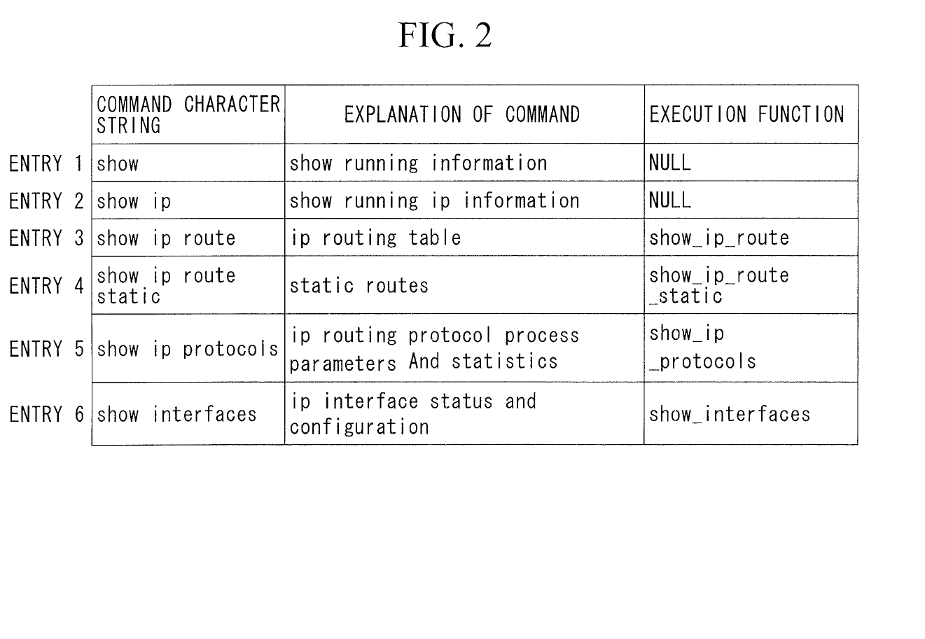

FIG. 2 is a table showing the configuration of the command correspondence table 103 and examples of registered data. As shown in FIG. 2, the command correspondence table 103 contains data items which represent command character strings (command pattern strings), command explanations, and the positions of the execution functions. The registered command character strings include a single, or a plurality of words. The command explanations explain the words registered as command character strings.

The entries registered in the command correspondence table includes both complete entries and incomplete entries. The complete entries are entries of commands which are executable based on the character strings, and the incomplete entries are entries of commands which are not executable based on the character strings. The incomplete entries store character strings which are parts of the command character strings of the complete entries, and are stored in the command correspondence table 103 in order to maintain the explanations of the words which constitute the command character strings of the complete entries.

In the examples shown in FIG. 2, entry 1 “show”, and entry 2 “show ip” are incomplete entries, while the other entries are complete entries. That is, entry 1 “show” is a part of the character strings of the complete entries 3 to 6. Entry 2 “show ip” is a part of the character strings of the complete entries 3 to 6. Entries 1 and 2 cannot independently function as commands.

In the examples, the addresses in the memory which indicate the starting points of the execution functions of the commands are registered as the position information of the execution functions of the complete entries. Since the incomplete entries do not have corresponding execution functions, “NULL” is registered as the position information of the execution function of the incomplete entries. The command correspondence table retriever 105 determines whether the entry is complete or incomplete based on “NULL”. An item indicating whether the entry is complete or incomplete may be created separately from the position information of the execution functions.

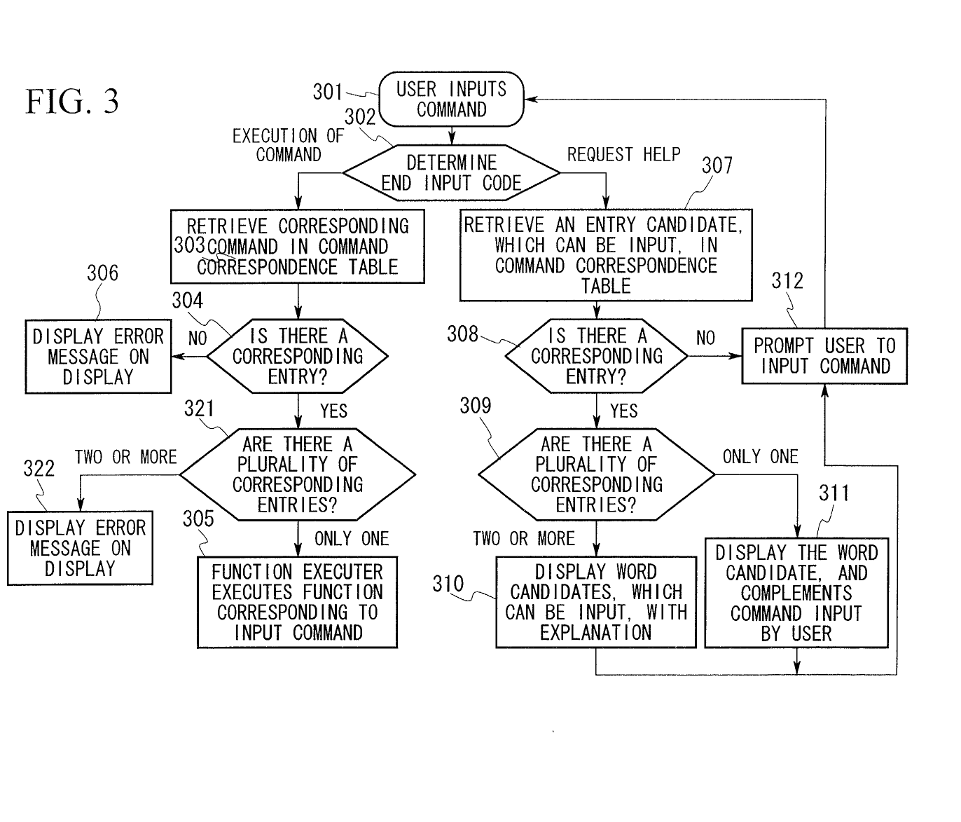

The operation of the shell system 102 will be explained with reference to the flowchart. FIG. 3 is a flowchart showing the process after the input of a command to the shell system 102. In step 301, when a user inputs the command to the input terminal 101, the input character string is sent from the command reader 104 to the command correspondence table retriever 105. The command correspondence table retriever 105 analyzes the character string to extract a word, and determines an end input code in step 302.

The end input code indicates whether the user requests the execution of the command of the character string or requests to display help information regarding the character string. For example, when the user presses the return key of the input terminal 101, an end input code indicating a request to execute the command is added to the input character string and is sent to the shell system 102. When the user presses “Help”, “?”, or “Tab”, an end input code indicating a request for help information is added to the input character string and is sent to the shell system 102. The keys corresponding to the end input codes are not limited to the above examples, and another keyboard may be used.

When the end input code indicates a request to execute the command, the command correspondence table retriever 105 retrieves the entry in the command correspondence table 103. In step 304 when the complete entry corresponding to the input character string is found and when there is a single entry in step S321, the command correspondence table retriever 105 extracts the position information of the execution function from the table in step 305, and the function executer 106, which has received the position information, calls the function and executes the command process. In step 304, if the complete entry is not found, the process is handled as an error, and an error message is displayed on the display of the input terminal 101 in step 306. In step 321, if there are a plurality of corresponding complete entries, the process is handled as an error, and an error message is displayed on the display of the input terminal 101 in step 322.

When the end input code determined in step 302 is a help request, the command correspondence table retriever 105 retrieves candidates, which the user can input, from the command correspondence table 103 based on the command character string which is being input by the user. If there is a single entry in step 308, or a plurality of entries corresponding to the input character string, and if in step 309, it is determined that there are a plurality of entries, all of the candidates of the entries are displayed with their command explanations extracted from the command correspondence table 103, and step 312 prompts the user to input the desired command.

If in step 309, it is determined that there is a single entry, the candidate command is displayed in step 311. Even when the input character string contains an incomplete word, and when a single entry can be determined, a command completion function replaces the incomplete word with the complete word, and displays it. If the corresponding entry is not found in step 308, an error message is displayed, and step 312 prompts the user to input the next command.

The retrieval from the command correspondence table 103 and its post-process will be explained by way of an example. The data shown in FIG. 2 is registered in the command correspondence table 103. When the user inputs “sh” and presses the TAB key, the syntax analysis determines that the input character string is a single word “sh”, and the command correspondence table retriever 105 recognizes the end input code for requesting help corresponding to the TAB key. The command correspondence table retriever 105 retrieves the command entry having the command character string (command pattern string) which starts with “sh” in the command correspondence table 103. Since there is one matching entry in the retrieval of the data shown in FIG. 2, the command pattern “show” is uniquely specified, and the command correspondence table retriever 105 replaces the input character string “sh” with “show”, and prompts the user to input a command.

When the user inputs “i”, and presses the TAB key, the input character string is “show i”, and the syntax analysis determines that the character string is a help request which constitute two words “show” and “i”. The command correspondence table retriever 105 retrieves an entry with two words of the command character string (command pattern string), which are the first word “show”, and the second word starting from “i”, in the command correspondence table 103. In the retrieval, since two entries, 2 and 6, are matched, the command cannot be uniquely specified, and the candidates and their command explanations are displayed.

Example:

>show i

interfaces—IP interface status and configuration

ip—Show running IP information

When the input character string is followed by a space, and then followed with the end input code indicating the help request, e.g., “show ip route”, the command correspondence table retriever 105 displays candidates following the character string. In this case, since the complete entries 3 and 4 correspond to the input character string, the candidates and their explanations are displayed.

Example:

>show ip route

static—Static routes

<cr>—IP routing table

According to the display, the user may input “static” after “show ip route” to execute the command constituting of four words. Alternatively, the user may press the RETURN key (carriage return, CR) to execute the command constituting of three words.

Next, the operation will be explained when an abbreviated command is input. For example, when the user inputs “sh ip r s”, and presses the RETURN key, the command correspondence table retriever 105 performs the syntax analysis, and determines that the character string is a command execution request constituting four words “sh”, “ip”, “r”, and “s”. The command correspondence table retriever 105 successively judges whether these words match the beginnings of the command character strings in the command correspondence table 103 (a beginning matching method). Since there is only one entry 1 whose beginning matches the “sh” and which is a single word, “sh” is replaced with “show” by the completion function.

When retrieving an entry corresponding to “show ip” in the command correspondence table 103, only the entry 2 is matched. Subsequently, when retrieving an entry corresponding to “show ip r” from the command correspondence table 103, only the entry 3 is found, “r” is therefore added, and the word is replaced with “route”. Finally, when retrieving an entry corresponding to “show ip route s” from the command correspondence table 103, only the entry 4 is found, and “s” is interpreted as “static”. Thus, the input character string “sh ip r s” is handled as the “show ip route static” command, and the address of the execution function show_ip_route_static is sent to the function executer 106 and is executed.

In response to the input of an abbreviated command character string to request the execution of a command, the retrieval from the command correspondence table 103 may find both a complete entry and an incomplete entry. In this case, the command is interpreted based on the complete entry. For example, when the input character string “sh i” requests the execution of the command, “sh” is replaced with “show” by completion function. The retrieval based on “show ip” finds entries 2 and 6. Entry 2 is incomplete, and entry 6 is complete. Therefore, entry 6 is adopted so that the command is interpreted as “show interface”, and then the function show_interfaces is executed.

During in the process for the command execution request based on the abbreviated command character strings, if a plurality of entries are matched, the execution request causes an error because the entry to be executed cannot be determined.

When receiving an abbreviated command character string, e.g., “sh ip r s”, with an end input code requesting the help, the command correspondence table retriever 105 performs an analysis similar to that for the request to execute a command as described above, completes the words, displays “show ip route static”, and waits for an input from the user. The user may then presses the RETURN key to request the execution of the “show ip route static” command.

When receiving an abbreviated command character string with an end input command, and when a plurality of entries are found in the command correspondence table 103, the candidate words and their explanations are displayed.

Example:

>show i

interface—IP interface status and configuration

ip—Show running IP information

For commands having variable character strings as parameters, command character strings (command pattern strings), which contain template symbols, are registered in the command correspondence table 103. For example, a complete entry having the command pattern string “set name %s”, corresponding to the command having the statement “set name (any arbitrary character string), is registered. In the retrieval by the command correspondence table retriever 105, the “%s” matches any arbitrary word. For example, an entry of a command pattern string “set paths %d”, corresponding to the command of the statement “set paths (value)”, is registered, and the “%d” matches any arbitrary character string. Template symbols other than “%s”, and “%d”, may be used.

For example, “%a” may be used as one of the template symbols, and “%a” may match any arbitrary IP address. A communicator such as a router stores an IP address corresponding to the operating environment as setting information. When receiving a help request with a character string in which the word corresponding to “%a” is not specified, the apparatus may display a plurality of candidate IP addresses, which the user can input, based on the setting information. The IP address is only an example, template symbols having other meanings may be used, and help information may be displayed based on setting information other than the IP address.

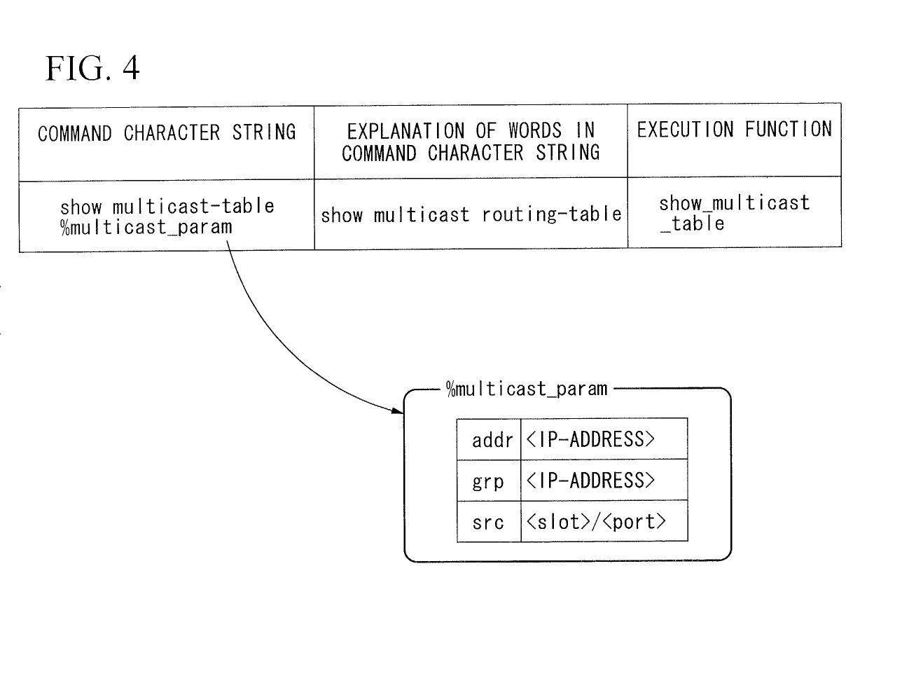

Another embodiment of the command processing apparatus of the present invention will be explained. FIG. 4 is a diagram showing the configuration of the command correspondence table, and examples of data. In FIG. 4, an entry whose command character string is “show multicast-table %multicast_param” is registered. The information regarding the specific contents of “%multicast_param” is stored in a sub-table (parameter table) shown in FIG. 4. In the examples, three parameters “addr”, “grp”, and “src” are registered in the sub-table. “Addr” and “grp” have a type “<IP-ADDRESS>”, and “src” has a type “<slot>”, or “<port>”.

The data in FIG. 4 indicates that the order of the “addr”, “grp”, and “src”, which are the parameters of “show multicast-table” is not limited. During the retrieval from the command correspondence table, the permutations (patterns) of the parameters are produced. When the input character string matches one of the patterns, it is determined that the input character string matches with the entry of the command pattern string. Thus, because the sub-table is used the command correspondence table, commands having parameters which have no specific order do not require the registration of all the permutations of the parameters.

While in this embodiment the command correspondence tables stores the addresses of the starting points of the functions in memory as the position information of the execution function, other information may be stored. For example, the names of the files having the execution codes for the respective functions may be used as the position information. The filenames may be used with information regarding the positions in the files.

The command processing apparatus is contained in the internal computer system. The process for parsing and executing the commands is stored in the form of a computer program in a storage medium of the computer system. The computer reads the program and executes it. The storage medium in the computer system may be a floppy disk, an optical-magneto disk, a CD-ROM, a magnetic hard disk, a semiconductor memory, or the like.

The program may provide only a part of the functions described above. The program may be a update program which is to be combined with the program which has been recorded in the computer program to provide the above-described functions.

The command correspondence table is stored in the storage unit. Specifically, the storage unit may be a main memory comprising a semiconductor RAM, or an auxiliary storage unit such as a magnetic disk, an optical disk, or a magneto-optical disk.

The command reader, the command correspondence table retriever, the command executer, and the command correspondence table may be installed in a single computer system, or may be distributed in a plurality of computer systems. For example, the command reader, the command correspondence table retriever, and the command executer may be provided in a single computer system, and the command correspondence table may be stored in another computer system. In this case, a communicator is provided between them so that the command correspondence table retriever can performs the retrieval from the command correspondence table. This configuration may be applied such that a plurality of command processing apparatuses in different computer systems have a single command correspondence table in common. In this case, if only one correspondence table is revised, all the command processing apparatuses can access the revised table.

A plurality of command correspondence tables may be prepared, and the respective users may reference the different command correspondence tables. This provides different systems to the respective users without any change in the execution function group. The configuration can change the executable commands, depending on the class to which the user belongs. Specifically, when the user is to login to the system, the user must input his user ID and password, and the system certifies the login. The attributes of the input user ID are “general user” or “privileged user”. A general user can only execute the commands for displaying the status. A privileged user can execute both commands for displaying the status and commands for changing the settings of the parameters. The system prevents an accidental change of the settings.

This invention may be embodied in other forms or carried out in other ways without departing from the spirit thereof. The present embodiments are therefore to be considered, in all respects, illustrative and not limiting, the scope of the invention being indicated by the appended claims, and all modifications falling within the meaning and range of equivalency are intended to be embraced therein.

1. A command processing apparatus comprising:
a command parser for parsing a command pattern string, based on an input character string, and for obtaining program execution information corresponding to the command pattern string; and
a command execution controller for executing a program based on the program execution information obtained by the command parser.

2. A command processing apparatus comprising:
a command correspondence table retriever for retrieving program execution information in a command correspondence table which stores the relationships between command pattern strings and program execution information for executing processes corresponding to the command pattern strings based on an input character string; and
a command execution controller for executing a program based on the program execution information obtained by the command correspondence table retriever.

3. A command processing apparatus according to claim 2, wherein the command correspondence table retriever retrieves an explanation corresponding to the input character string in the command correspondence table, and displays the explanation.

4. A command processing apparatus according to claim 2, which internally stores the command correspondence table.

5. A command processing apparatus according to claim 2, wherein the correspondence table stores explanation information corresponding to the command pattern strings.

6. A command processing apparatus according to claim 2, wherein the command correspondence table retriever retrieves the command pattern string in the command correspondence table by a pattern matching method based on the input character string, and displays the obtained complete command pattern string to a user.

7. A command processing apparatus according to claim 6, wherein the command correspondence table retriever performs the retrieval from the command correspondence table using a beginning matching method for finding a word contained in the command pattern strings in the command correspondence table whose beginning matches each word in the incomplete input character string.

8. A command processing apparatus according to claim 2, wherein, during the retrieval, when the input character string corresponds to a plurality of command pattern string candidates, the command correspondence table retriever shows a list of information regarding the candidates to a user.

9. A command processing apparatus according to claim 8, wherein, during the retrieval, when the input character string corresponds to a plurality of command pattern string candidates, the command correspondence table retriever obtains program execution information of one of the candidates, and the command execution controller executes a program, based on the program execution information.

10. A command processing apparatus according to claim 2, wherein the command correspondence table retriever performs retrieval from a parameter table associated with the command correspondence table using a matching method for finding a second command pattern string which is produced by arranging the parameters in an arbitrary order, which matches the input character string.

11. A command processing apparatus according to claim 2, further comprising a parameter table, associated with the command correspondence table, for storing information regarding parameters which have no specific order.

12. A command processing apparatus according to claim 1, wherein the program execution information represents position information indicating an entry point of a corresponding executable program file.

13. A command processing apparatus according to claim 1, wherein the program execution information represents information for identifying a corresponding executable program file.

14. A command processing apparatus according to claim 2, wherein the command correspondence table retriever identifies a user who inputs the character string, and performs the retrieval from one of the command correspondence tables based on the identification.

15. A communicator comprising:
a command processing apparatus comprising a command parser for parsing a command pattern string based on an input character string, and for obtaining program execution information corresponding to the command pattern string, and a command execution controller for executing a program based on the program execution information obtained by the command parser; and
an address memory unit for storing information regarding an address for communication, wherein
the command correspondence table retriever displays an explanation of a command for controlling the communication based on the address stored in the address memory unit.

16. A computer system comprising:
a command processing apparatus comprising a command parser for parsing a command pattern string based on an input character string and for obtaining program execution information corresponding to the command pattern string, and a command execution controller for executing a program based on the program execution information obtained by the command parser; and
a command correspondence table which is accessed by the command processing apparatus through a communication network.

17. A command processing method comprising:
a command parsing step of parsing a command pattern string, based on an input character string, and for obtaining program execution information corresponding to the command pattern string; and
a function execution step of calling a program, based on the program execution information obtained in the command parsing step.

18. A command processing method comprising:
a command correspondence table retrieval step of retrieving program execution information in a command correspondence table which stores the relationships between command pattern strings and program execution information for executing processes corresponding to the command pattern strings based on an input character string: and
a command execution step of calling a program based on the program execution information obtained in the command correspondence table retrieval step.

19. A command processing method according to claim 18, further comprising a syntax analysis step of parsing the input character string according to a predetermined rule, and of extracting words contained in the input character string based on the results of the syntax analysis step.

20. A command processing method according to claim 19, wherein the command correspondence table retrieval step receives the words obtained in the syntax analysis step, and performs the retrieval using a partial matching method.

21. A command processing method according to claim 19, wherein the command correspondence table retrieval step receives the words obtained in the syntax analysis step, and performs the retrieval using a beginning matching method.

22. A command processing method according to claim 19, wherein the command correspondence table retrieval step obtains a character string corresponding to a word contained in the input character string, and replaces a part of the input character string with the obtained character string.

23. A computer-readable storage medium containing program instructions for performing:
a command correspondence table retrieval step of performing the retrieval from a command correspondence table based on an input character string, and obtaining position information of an execution function corresponding to the input character string;
a function execution step of calling the execution function based on the position information obtained from the command correspondence table retrieval step; and
a command processing step of causing a computer to execute the execution function.

24. A computer-readable storage medium according to claim 23, containing program instructions for performing a syntax analysis step of parsing the input character string according to a predetermined rule, and of extracting words contained in the input character string based on the results of the syntax analysis step.

25. A computer-readable storage medium according to claim 23, wherein the command correspondence table retrieval step obtains a character string corresponding to a word contained in the input character string, and replaces a part of the input character string with the obtained character string.
